(19) United States
(12) Patent Application Publication
(10) Pub. No.: US 2026/0273835 A1
(43) Pub. Date: Sep. 17, 2026

(54) POLYMERIC MATERIALS WITH IMPROVED RESISTANCE THROUGH UNTRASONIC TREATMENT AND DENTAL APPLIANCES AND OTHER ARTICLES FORMED THEREBY

(71) Applicant: Bay Materials, LLC, Fremont, CA (US)

(72) Inventors: Ray F. Stewart, Blairsden-Graeagle, CA (US); John Lahlouh, San Jose, CA (US); Diyun Huang, Fremont, CA (US)

(21) Appl. No.: 19/671,519

(22) Filed: May 8, 2026

Related U.S. Application Data
(63) Continuation of application No. PCT/US2024/055052, filed on Nov. 8, 2024.
(60) Provisional application No. 63/597,791, filed on Nov. 10, 2023.

(51) Int. Cl. B29C 51/26; B29C 71/02; B29L 31/00

(52) U.S. Cl. CPC B29C 51/266; B29C 2071/022; B29C 2791/008; B29K 2995/0039; B29K 2995/004; B29K 2995/0083; B29L 2031/7532

(57) ABSTRACT

A method of treating a polymeric material includes exposing the polymeric material to ultrasonic energy in a liquid medium at a temperature below a glass transition temperature of the polymeric material for a time sufficient to modify one or more properties, or to reduce surface or internal stress, of the polymeric material, the one or more properties including stress relaxation, shape recovery, glass transition temperature, and crystallinity.

### CROSS-REFERENCE TO RELATED APPLICATION

This patent application is a continuation of International Application No. PCT/US2024/055052, filed Nov. 8, 2024, which claims priority to U.S. Provisional Patent Application No. 63/597,791, filed on Nov. 10, 2023, titled “POLYMERIC MATERIALS WITH IMPROVED RESISTANCE THROUGH UNTRASONIC TREATMENT AND DENTAL APPLIANCES AND OTHER ARTICLES FORMED THEREBY,” which are both incorporated herein by reference in their entireties.

### FIELD

The present disclosure relates to methods of improving the mechanical properties of polymer articles, including rigid, amorphous polymer articles, through ultrasonic treatment. Dental appliances and other articles formed in compliance with these methods have improved mechanical properties, including reduced stress relaxation.

### BACKGROUND

Clear aligner therapy involves the application of a series of one or more plastic “aligner” shells fitted to teeth. These types of dental appliances are useful for sequentially moving teeth in orthodontic treatment. Each aligner shell is formed so that it is displaced from one or more teeth such that the shell imparts forces to one or more teeth to move them toward a desired location different from their initial positions. The shells may be designed to move teeth in different directions, for example laterally, or rotationally, or in buccal or lingual directions or to produce intrusion or extrusion.

The aligner shells are typically constructed from polymeric materials. Examples include plastic sheets which are thermoformed over dental models representing each of the planned stages. The shells (also commonly referred to as positioners or aligners) are either single layer materials, for example polyester co-polymers or polyurethanes, or may be multi-layer structures. Examples of single layer structures include PETG materials such as Essix Ace™ sold by Dentsply and rigid polyurethanes such a Zendura™ sold by Bay Materials, LLC. Examples of multilayer materials include SmartTrack™ aligners sold by Align technology and Zendura FLX™ sold by Bay Materials, LLC, see, e.g., U.S. Pat. Nos. 10,549,511, 10,946,630, 10,870,263 and 10,987,907, which are each incorporated by reference for all purposes. Other different multilayer aligner materials have been described in International Patent Publication No. WO 2020/225651, and WO2021025967A1, which are each incorporated by reference.

In some cases aligner therapy may involve using more than one type of material, for example, two layer “hard/soft” materials (see for example orthocaps: https://www.orthocaps.com/was-is-orthocaps/#sec1), or a single layer “hard” material.

When polymeric materials are deformed they may suffer stress relaxation and/or creep, degrading their properties and limiting the performance of various products which are dependent on maintaining a fixed shape. Creep and stress relaxation are the main deformation mechanisms that polymers undergo. Deformation may occur when a polymeric material is processed, e.g., to produce a polymeric article such as a dental appliance, or when the polymeric article has been used or worn for a period of time.

Creep of a polymer article occurs when a force is continuously or intermittently applied to the article, causing it to deform gradually. The deformation of the polymer article is generally recoverable after the load is removed, but recovery takes place slowly with the polymer chains returning to their initial state. The rate at which polymers creep depends not only on the load, but also on temperature and, in general, a loaded component creeps faster at higher temperatures. Creep is readily measured using standard procedures, such as that set forth in ASTM D2990-01 or D790.

Stress relaxation is almost exclusively a characteristic of polymeric materials and is a consequence of delayed molecular motions as in creep. Contrary to creep, however, which is experienced when the load is constant, stress relaxation occurs when deformation (or strain) is constant and is manifested by a reduction in the force (stress) required to maintain a constant deformation. The degree to which stress relaxation is exhibited by a polymer depends on numerous factors such as polymer chemistry, molecular weight, type and amount of crystallinity in the polymer, glass transition temperature, environmental conditions, applied load and other factors. Often, it is not possible to readily predict what kind of stress relaxation a particular polymer material may exhibit until extensive testing and evaluation are conducted.

It is known that polymers can be annealed by subjecting them to temperatures slightly below their glass transition temperature for long periods of time. For example, a wet annealing process is disclosed in U.S. Pat. No. 8,716,425 which uses a combination of moisture and temperature to reduce stress relaxation of polymers including polyurethanes.

U.S. Pat. No. 4,847,033 describes a process for decreasing the “free volume” of a polyethylene terephthalate (PET) film by first heating to a temperature below the glass transition (Tg), then tensioning the article, and then heating again below Tg. The heating process induces stress relaxation, i.e., induces a relaxation of the stresses in the polymer, and does not prevent stress relaxation.

U.S. Pat. No. 4,900,502 discloses wet annealing below the glass transition temperature of microporous hollow fibers. The microporous fibers are formed of polysulfone, polyethersulfone, polyphenylsulfone, polyvinylidenefluoride, polyimide, or polyetherimide. The effects of heat treatment on microporous polymer articles does not relate to the effects of heat treatment on non-microporous polymer articles.

U.S. Pat. No. 6,171,758 describes annealing a semi-crystalline polymer by heating it to a temperature above the glass transition and below the melting point to improve dimensional stability.

U.S. Pat. No. 6,375,978 describes annealing of polymer membranes at temperatures 5-30° C. below the melting temperature of the polymer and above the glass transition temperature.

U.S. Pat. Nos. 4,816,342 and 4,770,944 describe wet annealing of ethylene vinyl alcohol co-polymers, polyvinyl alcohol, and nylon to increase crystallinity. The annealing is done at temperatures above the glass transition temperature.

https://doi.org/10.1016/j.ultsonch.2017.07.036 describes a process for patterned crystallization of amorphous polyethylene terephthalate using high-intensity focused ultrasound (HIFU) which is presumed to work by localized heating.

Prior art methods of annealing have required very specific temperature/time regiments and can be quite cumbersome. For example, polymer annealing normally involves the heating of material around its Tg. Such treatment will reorient the polymer chain structure, relieve internal stress developed during thermal process, and improve polymer mechanical properties. A dry annealing, including heating the material in air at certain rate to certain temperature, holding at that temperature for certain time, followed by cooling down at certain rate, normally takes a very long time, e.g., many hours. Wet annealing involves the heating in a liquid media such as water. U.S. Pat. No. 8,716,425 describes a wet annealing method to improve material stress relaxation, which also requires long treatment time.

### SUMMARY

The present embodiments provide polymeric materials with improved properties through ultrasonic treatment, and dental appliances or other polymeric articles made using such polymeric materials and processed using ultrasonic treatment. The present embodiments advantageously enable to condition, recondition and/or restore a deformed polymeric article.

The embodiments herein provide methods of wet annealing based on ultrasonication at certain combinations of frequency, time, temperature and/or power density, to greatly improve the treatment efficiency and enhance material performance in force retention, shape retention and shape recovery of polymeric articles, such as polymeric dental appliances.

According to embodiments herein, ultrasonic treatment advantageously addresses the problem of stress relaxation and/or creep in polymeric materials subjected to strain. In general, sonication of the polymeric material reduces surface or internal stress, and may enhance one or more properties including stress relaxation, shape recovery, glass transition temperature, and crystallinity.

In some embodiments, polymeric materials with improved properties including improved stress relaxation and shape recovery can be readily prepared by treatment with ultrasonic energy. In another embodiment polymeric articles which have been deformed can more rapidly and completely return to their original shape by treatment with ultrasonic energy at suitable temperatures. The treatment process can advantageously be carried out well below the glass transition of the material eliminating or reducing warping or undesired shape changes. The process can be conveniently conducted in a controlled temperature Ultrasonic Bath as a conditioning step.

In one embodiment, dental appliances are produced having improved tooth moving or retaining properties using aligners formed of one or more polymeric materials that are exposed to sonication. Sonication may be used either after formation and before use (to provide an enhanced aligner) or after use (e.g., to restore a deformed aligner) or both after formation and after any use or deformation.

According to an embodiment, a method is provided for treating a polymeric material, the method including exposing the polymeric material to ultrasonic energy in a liquid medium at a temperature below a glass transition temperature of the polymeric material for a time sufficient to modify one or more properties, or to reduce surface or internal stress, of the polymeric material, the one or more properties including stress relaxation, shape recovery, glass transition temperature, and crystallinity.

In certain aspects, the temperature is from about room temperature to about 5° C. below the glass transition temperature of the polymeric material.

In certain aspects, the method further includes determining the glass transition temperature of the polymeric material.

In certain aspects, the exposing includes thermoforming the polymeric material into a thermoformed article having a geometry, and thereafter exposing the thermoformed article to the ultrasonic energy in the liquid medium. In certain aspects, the thermoformed article comprises a dental appliance.

In certain aspects, the dental appliance is made via a 3D printing process or a molding process.

In certain aspects, the polymeric material comprises two or more layers of different polymers.

In certain aspects, the polymeric material comprises a single polymer.

In certain aspects, the polymeric material includes one or more polymers selected from the group consisting of polyamides, polyimides, polyurethanes, polyesters, polyureas, polycarbonates, polyether diols, polyolefins, polyacrylates, polymethacrylates, polystyrenes, polysulfones, polyaryl ethers, silicones, and cellulose.

In certain aspects, the polymeric material is a linear polymer, a branched or hypobranched polymer, or a crosslinked polymer.

In certain aspects, the liquid medium includes water or de-ionized water

In certain aspects, the ultrasonic energy comprises one or more frequencies.

In certain aspects, the ultrasonic energy comprises one or more frequencies between about 5 KHz and 1000 KHz, 5 KHz and 500 KHz, 10 KHz and 200 KHz, 10 KHz and 150 KHz, or 10 KHz and 100 KHz.

In certain aspects, the ultrasonic energy has an energy density of between about 0.005 W/ml to about 0.25 W/ml.

In certain aspects, the ultrasonic energy is applied for at least 1 min, at least 5 min, at least 1 hr, at least 4 hr, or at least 6 hr.

In certain aspects, the ultrasonic energy is applied in a sweep mode or a pulse mode.

In certain aspects, the polymeric material is substantially amorphous or semi-crystalline.

In certain aspects, the temperature varies and/or the frequency of ultrasonic energy varies during the exposing.

According to an embodiment, a dental appliance with improved properties comprising a polymeric material treated according to the methods herein.

According to an embodiment, a method of reducing stress relaxation and/or creep in a polymeric article is provided, the method including adjusting a temperature of the polymeric article in a liquid medium to a temperature that is below a glass transition temperature of the polymeric material; and exposing the polymeric article to ultrasonic energy in the liquid medium at the temperature for a time sufficient to reduce stress relaxation of the polymeric article, wherein the exposing the polymeric article to ultrasonic energy reduces stress relaxation and/or creep resistance in the polymeric article by at least about 5% or 10% as compared to the stress relaxation and/or creep resistance of the polymeric article before the exposing.

In certain aspects, the method further includes determining the glass transition temperature of the polymeric article.

In certain aspects, the adjusting the temperature of the polymeric article includes placing the polymeric article in the liquid medium and then adjusting the temperature of the liquid medium to the temperature that is below a glass transition temperature of the polymeric material.

In certain aspects, the adjusting the temperature of the polymeric article includes placing the polymeric article in the liquid medium which is held at the temperature that is below a glass transition temperature of the polymeric material.

In certain aspects, the temperature is from about 50° C. to about 5° C. below the glass transition temperature of the polymeric article.

In certain aspects, the method further includes, prior to the adjusting, thermoforming the polymeric article into a geometry. In certain aspects, the thermoformed polymeric article comprises a dental appliance.

In certain aspects, the polymeric material comprises two or more layers of different polymer materials.

In certain aspects, the polymeric article comprises a single polymer material.

In certain aspects, the polymeric article includes one or more polymers selected from the group consisting of polyamides, polyimides, polyurethanes, polyesters, polyureas, polycarbonates, polyether diols, polyolefins, polyacrylates, polymethacrylates, polystyrenes, polysulfones, polyaryl ethers, silicones, and cellulose

In certain aspects, the liquid medium includes water or de-ionized water.

In certain aspects, the ultrasonic energy comprises one or more frequencies.

In certain aspects, the ultrasonic energy comprises one or more frequencies between about 5 KHz and 1000 KHz, 5 KHz and 500 KHz, 10 KHz and 200 KHz, 10 KHz and 150 KHz, or 10 KHz and 100 KHz.

In certain aspects, the ultrasonic energy has an energy density of between about 0.005 W/ml to about 0.25 W/ml.

In certain aspects, the polymeric article is a dental appliance, such as a dental aligner.

In certain aspects, the polymeric article is substantially amorphous or semi-crystalline.

In certain aspects, the temperature varies and/or the frequency of ultrasonic energy varies during the exposing.

According to an embodiment, a dental appliance with improved properties is provided that includes a polymeric material processed according to the methods herein.

According to an embodiment, a method is provided for restoring a deformed dental appliance, the dental appliance comprising a polymeric material, the method including adjusting a temperature of the dental appliance in a liquid medium to a temperature that is below a glass transition temperature of the polymeric material; and exposing the dental appliance to ultrasonic energy in the liquid medium at the temperature for a time sufficient to reduce stress relaxation of the polymeric material, wherein the exposing the dental appliance to ultrasonic energy reduces stress relaxation and/or creep resistance in the polymeric material by at least about 5% or 10% as compared to the stress relaxation and/or creep resistance of the polymeric material before the exposing.

According to an embodiment, a system for modifying the properties of a dental appliance includes the dental appliance, wherein the dental appliance comprises a polymeric material; an ultrasonic treatment device comprising a fluid containing chamber, a heating (or cooling) element configured to heat the fluid containing chamber, and an ultrasonic transducer, wherein the treatment device is configured to adjust a temperature of the dental appliance in the fluid containing chamber to a temperature that is below a glass transition temperature of the polymeric material; and activate the ultrasonic transducer to subject the dental appliance to ultrasonic energy in the fluid containing chamber at the temperature for a time sufficient to reduce stress relaxation of the polymeric material.

In certain aspects, the dental appliance being subjected to ultrasonic energy reduces stress relaxation and/or creep resistance in the polymeric material by at least about 10% as compared to the stress relaxation and/or creep resistance of the polymeric material before being subjected to ultrasonic energy.

In certain aspects, the polymeric material includes one or more polymers selected from the group consisting of polyamides, polyimides, polyurethanes, polyesters, polyureas, polycarbonates, polyether diols, polyolefins, polyacrylates, polymethacrylates, polystyrenes, polysulfones, polyaryl ethers, silicones, and cellulose.

According to an embodiment, a method is provided for restoring the force capabilities of a deformed dental appliance, the method including forming the dental appliance, the dental appliance comprising a polymeric material; setting the dental appliance to a first shape by treating the dental appliance with ultrasonic energy at a first temperature that is below a glass transition temperature of the polymeric material; exposing the dental appliance to a deformation process to deform the dental appliance; and at least partially restoring the dental appliance to the first shape by treating the deformed dental appliance with ultrasonic energy at a second temperature that is below the glass transition temperature of the polymeric material.

In certain aspects, the first temperature and the second temperature are the same or different.

In certain aspects, the deformation process includes use by a patient wearing the dental appliance for a period of time.

In certain aspects, the forming the dental appliance includes thermoforming the polymeric material into a thermoformed article having a geometry.

In certain aspects, the treating the dental appliance with ultrasonic energy at the first temperature or the second temperature includes exposing the dental appliance to ultrasonic energy in a liquid medium at the first temperature or the second temperature for a time sufficient to reduce stress relaxation of the polymeric material, wherein the exposing the dental appliance to ultrasonic energy reduces stress relaxation and/or creep in the polymeric material by at least about 5% or 10% as compared to the stress relaxation and/or creep resistance of the polymeric material before the exposing.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

The detailed description is described with reference to the accompanying figures. The use of the same reference numbers in different instances in the description and the figures may indicate similar or identical items

FIG. 1A is a schematic depiction of a cross sectional view of a three-layer polymeric sheet with a simple ABC construction.

FIG. 1B is a schematic depiction of a cross sectional view of a multiple layer polymeric sheet.

FIG. 2 shows the outline of a process used for ultrasonically conditioning and testing polymer materials and articles.

FIG. 3 shows recovery for Zendura A based on ULS and wet annealing processes.

FIG. 4 shows a graph of the 24 hour Recovery % in various rigid amorphous polymers conditioned for two hours in 60° C. de-ionized water with and without application of ultrasonic energy.

FIG. 5 shows a graph of the 24 hour Recovery % in Eastar 6763 PETG conditioned in five different manners.

FIG. 6 shows a graph of the 24 hour Recovery % in ZenduraA, Grilamid TR90 and COEX 2531, tested after three different conditions: 48 hours at ambient temperature; two hours in 60° C. de-ionized water; and two hours in 60° C. de-ionized water with Ultrasonic Power on.

FIG. 7 shows a graph of the DSC Heat1 or Heat2 Tg° C. values for the various rigid amorphous polymers, after different conditioning: normalized; 60° C. in H₂O for 2 hours; Sonicated at 60° C. in H₂O for 2 hours.

FIG. 8 shows recovery for ZenduraFLXA based on ULS and wet annealing processes.

FIG. 9A and FIG. 9B show the ULS time effect on Zendura A and Zendura FLX materials, respectively.

FIG. 10A and FIG. 10B show the ULS temperature effect on Zendura A and Zendura FLX materials, respectively.

FIG. 11A and FIG. 11B show the ULS frequency effect on Zendura A and Zendura FLX materials, respectivelyFIG. 12 shows improvement in elastic recovery is found for both Zendura A and Zendura FLX samples with ULS treatment.

FIG. 13A and FIG. 13B show the ULS mode effect on Zendura A and Zendura FLX materials, respectively.

FIG. 14 shows that longer wrapping time leads to lower 24 hours elastic recovery %.

FIG. 15 shows that improvement in recovery % are observed for both wet annealing and ULS treatments.

FIG. 16 shows Zendura FLX TW 1 hour Mimicking of Patient On-and-Off Behavior.

FIG. 17 shows Zendura FLX TW 2 hour Mimicking of Patient On-and-Off Behavior.

### DETAILED DESCRIPTION

The present disclosure relates to polymeric materials, and dental appliances formed of polymeric materials. The present embodiments provide polymeric materials, including dental appliances or other polymeric articles made using such polymeric materials, with improved properties through ultrasonic treatment. The present embodiments also advantageously enable reconditioning or restoring a deformed polymeric article.

The present embodiments advantageously provide improved force retention and shape recover properties in polymeric materials. For dental or orthodontic appliances, such as aligners, made of polymeric materials, the present embodiments advantageously provide improved force retention and shape recover properties in these appliances, which leads to optimized tooth movement and more predictable outcomes, allowing improved treatment and user experience for customers. Additionally, embodiments herein offer a rapid and cost-effective way to produce orthodontic appliances with better shape fixity, elasticity and improved tooth moving force. Moreover, a customer or other user or technician is able to easily activate the appliance (e.g., aligner) while cleaning the appliance in a bath with simultaneous sonication.

### I. DEFINITIONS

As used herein, the term “stress relaxation” refers to the percent loss of tension or load between the maximum load or force encountered after elongating an elastic material at a specified rate of extension to a predetermined length (or the load or force measured at some initial length) and the remaining load or force measured after the sample has been held at that length for a specified period of time, for example, from about 0 minutes to about 24 hours. Except where otherwise noted for the present invention, stress relaxation is expressed as a percentage loss of the initial load encountered at a specified extension. The stress relaxation is determined according to the method set forth in the methods section below. Alternative methods of determining stress relaxation are known in the art, such as testing on an Instron® Model 5565 Universal Test Machine using ASTM micro tensile specimens.

As used herein, the term “shape recovery” refers to the ability of a polymer to recover it shape. For example, in an embodiment, shape recovery refers to the ability of a polymer to recover it shape after 24 hours at 37° C. in deionized water at 5% strain. The Shape Recovery test is used to measure the percentage of original polymer shape recovered, after 24 hours under 5% strain in 37° C. DI water. As an example, a polymer strip measuring 101.75×25.4×0.76 mm (L, w, t) is wrapped around a PVC pipe (48.25 mm diameter), clamped at the two ends, and immersed in 37° C. DI water for 24 hours. At the end of the test period, the clamps are removed, and the strip allowed to recover freely for 24 hours in air. The 24-hour shape recovery (%) may be determined according to the following equation:

$$24 hour shape recovery ( \% ) ( E 24 ) = 100 \times ( 1 - ( ( ( L - L 24 ) / ( L - L 0 ) ) ) ,$$

L=full length of strip, e.g., 101.75 mm
L0=distance between opposite ends of clamped strip, e.g., 43.5 mm
L24=distance (mm) between opposite ends of free strip after 24 hour recovery.

As used herein, the terms “force retention” and “stress retention”, refer to the force [pound-force (lbf), gram-force (gf), etc.] required to maintain a specified constant strain.

As used herein, the term “thermoplastic” refers to any material which can be melted and resolidified with little or no change in physical properties (assuming a minimum of oxidative degradation).

“Creep resistance” refers to dimensional stability of a material to irreversible deformation on prolonged action of an applied force at a given temperature. A material which has good “dimensional stability” has a low stress relaxation and/or a high resistance to creep and therefore resists changes in shape during use.

As used herein, the term “glass transition temperature” refers to the gradual and reversible transition in amorphous and semicrystalline materials from a “glassy” state into a viscous or rubbery state as the temperature is increased.

The term “dental appliance” is used herein with reference to any device placed in or on the teeth of a subject. Dental appliances include but are not limited to orthodontic, prosthetic, retaining, snoring/airway, cosmetic, therapeutic, protective (e.g., mouth guards) and habit-modification devices. One example of a dental appliance is an aligner, e.g., clear aligner.

The term “polymeric sheet” is used interchangeably herein with the term “plastic sheet”.

The term “about,” as used herein with reference to a numerical value means the value may be within a small (e.g., no more than 10%) percentage of the value, e.g., within 10% or 5% or 2%, For example, “about 50” may include 45 to 55 and about 3000 may include 2700 to 3300.

The term “shell” is used herein with reference to a polymeric article which fits over the teeth of a patient or user and is removably placeable over the teeth.

### II. TREATMENT OF POLYMERIC MATERIALS OR ARTICLES

According to an embodiment, methods are provided for improving the mechanical properties of polymers, and in particular of rigid, amorphous polymers. A ‘rigid’ polymer refers to a polymer that has a glass transition temperature (Tg) of at least about 20° C., more preferably of at least about 30° C., still more preferably of at least about 40° C.

The methods include subjecting or exposing a polymeric material, or an article made of a polymeric material, to ultrasonic energy in a liquid medium at a temperature below a glass transition temperature of the polymeric material for a time sufficient to modify one or more properties, or to reduce surface or internal stress, of the polymeric material. For example, the one or more properties may include stress relaxation, shape recovery, glass transition temperature, and crystallinity.

For example, a method embodiment for reducing stress relaxation and/or creep in a polymer article includes adjusting (e.g., heating) a temperature of the polymer article in a liquid medium (e.g., in a liquid bath) to a temperature that is below a glass transition temperature of the polymeric material, and exposing the polymeric article to ultrasonic energy in the liquid medium at the temperature for a time sufficient to reduce stress relaxation of the polymeric article. The exposure to ultrasonic energy (sonication) reduces stress relaxation and/or creep in the polymeric article by at least about 10% as compared to the stress relaxation and/or creep resistance of the polymeric article before the exposure. The exposure time to ultrasonic energy (sonication time) may be as little as a few minutes, e.g., 5 or 10 minutes, to as much as a few days, e.g., 1 or 2 or 3 days or more. During the sonication, the temperature of the polymeric article is preferably held constant, but in some embodiments the temperature may be varied, e.g., increased or decreased over time. For example, the temperature during sonication (that is below a glass transition temperature of the polymeric material) may be from about 100° or about 50° C. to about 5° C. or less below the glass transition temperature of the polymeric material or article, and is generally dependent on the polymer Tg.

In certain embodiments, the ultrasonic energy interacting with the polymeric material or article in the liquid medium may include a single frequency or multiple frequencies. For example, the ultrasonic energy provided may include one or more frequencies between about 5 KHz and 1000 KHz, 5 KHz and 500 KHz, 10 KHz and 200 KHz, 10 KHz and 150 KHz, or 10 KHz and 100 KHz. Furthermore, any ultrasonic energy frequency applied may be controlled to vary over time, e.g., in response to a control signal that controls the ultrasonic transducer. The energy density supplied to the submerged articles may be between about 0.005 W/ml to about 0.25 W/ml or 0.3 W/ml.

In certain embodiments, the ultrasonic energy interacting with the polymeric material or article in the liquid medium may be applied in a sweep mode or a pulse mode.

Equipment for ultrasonic treatment may include any device having a liquid bath and a source of ultrasonic energy (e.g., power connected to one or more ultrasonic transducers) for delivering ultrasonic energy to an article placed in the liquid bath. Typically the liquid bath includes a liquid medium such as water or de-ionized water, but any useful liquid may be used. A control system, including a processor, enables control of the ultrasonic transducer(s) through control signals, e.g., to control the frequencies and/or energy supplied by the transducer(s).

In certain embodiments, a method may include determining a glass transition temperature of the polymer material or polymeric article and then heating the polymer at a temperature that is below the determined glass transition temperature and exposing the heated article to ultrasonic energy for a time sufficient to improve a desired mechanical property such as stress relaxation and/or creep resistance. Methods to determine the glass transition temperature are well known to those skilled in the art and may include differential scanning calorimetry (DSC) techniques or measurements, examples of which are provided in the examples section below.

In certain embodiments, adjusting the temperature of the polymeric article includes placing the polymeric article in a liquid medium (e.g., the liquid bath of an ultrasonic treatment system) and then adjusting the temperature of the liquid medium to the temperature that is below a glass transition temperature of the polymeric material. In some embodiments, adjusting the temperature of the polymeric article includes placing the polymeric article in the liquid medium, which is may be held at the temperature that is below a glass transition temperature of the polymeric material.

In some embodiments, the method includes processing a polymeric material with ultrasonic energy as described herein prior to forming a polymeric article. In some embodiments, the method includes processing a formed polymeric article with ultrasonic energy as described herein. For example, the ultrasonic treatment techniques disclosed herein are useful for restoring the mechanical properties of the polymeric article that has been used or somehow subjected to a strain or stress. An example is a polymeric dental or orthodontic aligner that may have been worn for a period of time.

In an embodiment, the polymeric material or article is heated to a temperature that is about 5° C. to about 50° C. (or larger), or 5° C.-25° C. lower than the determined or known glass transition temperature. The polymeric material or article is heated at the selected temperature and exposed to ultrasonic energy for a time sufficient to achieve an improvement in a desired mechanical property, and in particular to achieve a reduction in the stress relaxation of the polymer article. As used herein the phrase “for a time sufficient to achieve an improvement in . . . ” or “for a time sufficient to reduce stress relaxation” intends a time period that can be determined based on the guidance provided herein. Typically, the time period is from about 1 hour to 24 hours, however times of considerably longer than 24 hours may be needed in some situations. The optimal time period to improve a mechanical property, such as a reduction in stress relaxation, is readily determined by measuring the mechanical property as a function of time during heating at the selected temperature. When the mechanical property has improved a desired amount or when continued improvement with further time becomes de minimis, the time to improve the mechanical property is sufficient.

In the supporting examples, below, rigid amorphous polymers were selected to illustrate the beneficial effects achieved by the ultrasonic treatment methods herein. Various rigid, amorphous polymeric articles were treated by heating below the glass transition temperature for various times. The stress relaxation of the polymer articles were determined at various temperatures and for various ultrasonic energy exposure times, including with no ultrasonic energy exposure. These examples demonstrate the benefits (e.g., increased elastic recovery and reduced stress relaxation) of low temperature ultrasonic annealing on rigid amorphous polymers, including on thermoformed polymeric articles.

For instance, Example 1 illustrates an ultrasonic treatment method and its effects on stress relaxation and elastic recover of a polymer (ZenduraA, a monolayer polymer material, is a rigid polyurethane comprised of 1,6 hexanediol and MDI (MDI=methylene diphenyl diisocyanate) primary isomer is 4-4′, and it may have minor amounts of other diols and isocyanaters), including thermoformed articles and non-thermoformed materials. In particular, the polymeric materials and articles were heated to temperatures (60° C. and 85° C.) below the glass transition temperature ~95° C. and some were subjected to sonication. Those samples subjected to sonication exhibited increased elastic recovery and reduced stress relaxation compared with samples not subjected to sonication.

Additionally, Example 2 illustrates an ultrasonic treatment method and its effects on stress relaxation and elastic recover of a variety of rigid amorphous polymer materials, including for example, Thermoplastic Polyurethanes, Cyclic Olefin Compounds, Amorphous Polyamides, PETG, PCTG and PCTA Copolyesters. crystalline Polyamides and others. In particular, the polymer materials were hot pressed, then heated to temperatures below the glass transition temperature and some were subjected to sonication. Those samples subjected to sonication exhibited increased elastic recovery and reduced stress relaxation compared with samples not subjected to sonication.

Other examples illustrate the effects of ultrasonic treatment on stress relaxation of various polymeric materials, and effects based on changes in various ultrasonic parameters and other parameters such as ultrasonic (ULS) frequency, exposure time, exposure temperature, ULS power and ULS mode (e.g., sweep mode or pulse mode). Those samples subjected to sonication exhibited significant improvement in force retention.

In general, any polymeric materials, and in particular any amorphous or substantially amorphous rigid polymer, may be processed or treated in accordance with the present embodiments. Examples include polyamides, polyimides, polyurethanes, polyesters, polyureas, polycarbonates and polyethers, acrylics, methacrylics acetals, polyketones, epoxies, etc.

In some embodiments, a set of one or more dental appliances may be prepared with improved properties, e.g., improved stress relaxation and creep resistance properties, using polymeric materials treated with sonic energy as described herein.

In some embodiments, a deformed dental appliance may be restored, e.g., after use, using systems and methods for treating polymeric materials and articles with sonic energy as described herein.

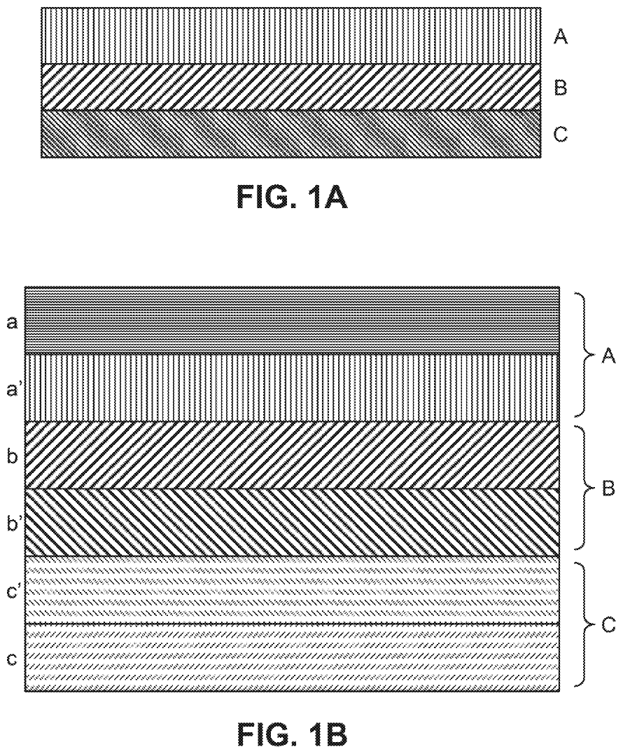

Polymeric materials or articles, such as polymeric orthodontic aligners, may have a simple, e.g., single material or mono-layer construction formed from a single polymeric sheet, and others may have a more complex construction, such as a multi-layer construction. FIG. 1A is a schematic depiction of a cross sectional view of a three-layer polymeric sheet with a simple ABC construction. For the simple ABC construction, layer A and layer C may be the same or different materials and each layer may be comprised of one or more materials, or blends or alloys; layer B may be a single material, or a blend of materials or alloys, and may be formed using one or more polymeric sheets.

FIG. 1B is a schematic depiction of a cross sectional view of a multiple layer polymeric sheet. Each layer A, B and C, may be a comprised of a single layer or multiple layers and each layer may be comprised of one or more materials or a blend of materials. Layer A may be comprised of more than one layer, for example, layer a and a′, layer B may be comprised of more than one layer, for example, layer b and b′, and layer C may be comprised of more than one layer, for example, layer c and c′, as exemplified in FIG. 1B.

Additionally, the multilayer may comprise additional tie layers between different polymers as is known in the art.

Polymeric aligners, and other polymeric articles, may be formed by thermoforming, 3D printing or other techniques as known to those skilled in the art. In certain embodiments, for example, multilayer polymeric sheets may be prepared by a number of means including without limitation, hot or cold lamination, adhesive lamination, melt lamination, coextrusion multilayer extrusion or other known methods. Polymeric sheets may be fully prepared before forming into an orthodontic appliance, or an appliance may be produced using a sequence of individual thermoforming steps to create multiple layers.

Thermoforming of polymeric sheets to produce test samples or dental appliances may be performed using a “Biostar” pressure former available from Great Lakes Orthodontics using procedures commonly used in the industry. Alternatively, thermoforming may be performed using a roll fed thermoformer, a vacuum former or other known thermoforming techniques. Thermoforming may be conducted using different conditions, forms or models to vary draw ratio and part thickness. Multilayer appliances may be fabricated through one or more 3D printing processes or by sequential dip coating, spray coating, powder coating or similar processes known for producing films, sheets and 3D structures.

It should be understood that elements of two or more embodiments may be combined.

### III. EXAMPLES

It should be appreciated that the constructions and properties illustrated in the Examples and accompanying Figures are specific examples and not intended to limit the scope of constructions, materials and testing that may be used. Other materials, constructions and sequences of steps may also be performed according to alternative embodiments. For example, alternative embodiments may contain additional layers including tie layers, pigments, optical additives or reinforcing agents and may be constructed in any manner known in the art such as flat sheet extrusion, coextrusion blown film, calendaring, laminating and adhesive bonding. The structures (or polymer sheets) and devices may in some embodiments be made by 3D printing or dip coating. One of ordinary skill in the art would recognize and appreciate many variations, modifications, and alternatives of the constructions.

### Example 1—Zendura A

One lot of Zendura A, a rigid polyurethane was processed as both cut WIP sheets post dried in desiccant drying oven and by rotary cut direct to bag with post heating. Dried parts were tested after conditioning for stress relaxation and elastic recovery. Parts from each thermal history were thermoformed and tested after ambient, wet, and ultrasonic conditioning.

Parts tested after drying and ambient conditioning showed a higher elastic recovery and lower stress relaxation for parts dried at 85° C. desiccant oven vs. the 60° C. post drying used for rotary direct to bag. This is likely due to annealing in the 85° C. oven process being more efficient at a temperature much closer to the Zendura A Tg of ~°95 C.

Thermoforming the dried sheets (50 sec, 220° C. set point; typical surface temperature reaching about 160° C.) removed the annealing effect from drying temperatures and returned the material to lower recovery and high stress relaxation as expected.

Wet annealing and in particular ultrasonic assisted annealing increased the performance (e.g., improved elastic recovery and reduces stress relaxation) of materials, including post-thermoformed materials or articles, from either cut and dry process.

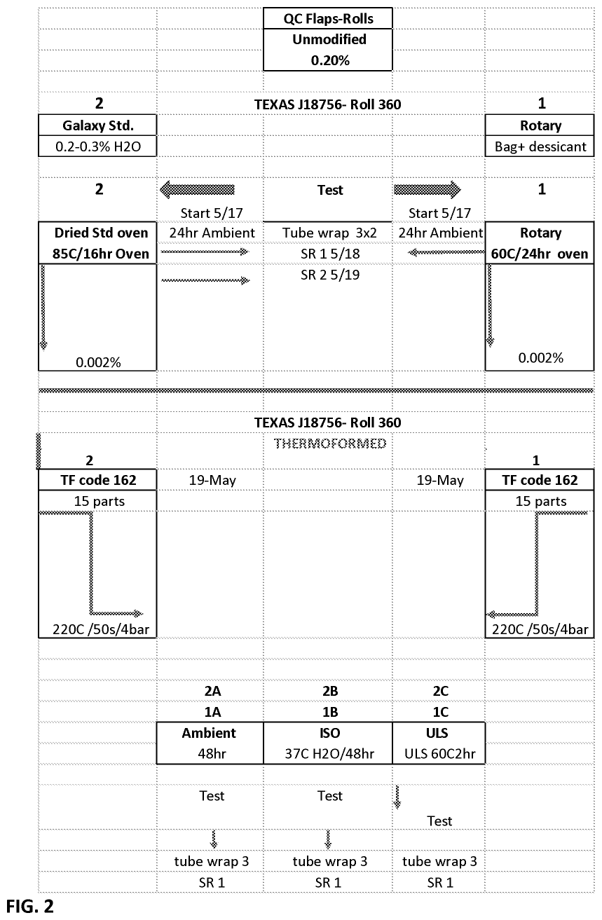

FIG. 2 shows the outline of the process used for conditioning and testing parts in this Example.

Samples preparation: Standard Zendura A was cut and dried by standard qualified production processes:

1) Dry packaged slit roll from vendor was rotary cut with 125.5 mm die and packaged immediately as single sheets. The packaged product was then heated for 24 hours in standard oven to dry any residual moisture from the cut sheet.

2) A slit roll was cut into 125.5 mm sheets and in a later step loaded into ovens dried 16 hr at 85° C. These samples were then manually packaged as single sheets.

Samples Thermoforming: Samples were removed from the barrier bags and thermoformed over a flat acrylic block.

Samples Conditioning: Three different Conditioning processes were applied to the thermoformed sheets:
i. Ambient lab temperature and humidity. Samples were allowed to sit exposed (both sides) to ambient lab air for 48 hours.
ii. Heating Immersed in 37° C. de-ionized water. Thermoformed sheets were punched into three strips 1″×4″ and one 1″×2″ piece. These were immersed in de-ionized water in a glass container and heated in an oven at 37° C. for 48 hours.
iii. Ultrasonic treatment immersed in 60° C. de-ionized water. An ultrasonic bath, Branson 2510, was set to 60° C. water temperature. Three 1″×4″ strips and one 1″×2″ piece were immersed in 300 ml de-ionized water in a glass container, placed in the bath, and allowed to equilibrate to set temperature. Sonication was turned on for two hours. Sonicated samples were then removed to room temperature.

### Testing:

iTube Wrap (TW) and Stress Relaxation tests were perfumed.

Results: Table 1 shows the results for both elastic recovery and stress relaxation.

TABLE 1
Comparison of Results for Initial Parts and those Thermoformed
and Conditioned Summary of certain findings:

| | | E. | Retained | Force | Force |
|---|---|---|---|---|---|
| | Thickness, | Recovery | Force % | g @ | g @ |
| Part Condition | mm | % | (24 hr/1 hr) | 24 hr | 1 hr |
| Rotary 60 C. 24 hr | 0.75 | 33 | 27.4 | 678 | 2474 |
| Std 85 C. 16 hr dry | 0.75 | 69 | 49.2 | 1453 | 2953 |
| TF'd Rotary 60 C.- Ambient 48 hr | 0.67 | 28 | 26.5 | 335* | 1262 |
| TF'd Rotary 60 C.-ISO 48 hr | 0.69 | 63 | 47.7 | 996 | 2088 |
| TF'd Rotary 60 C.-ULS | 0.70 | 63 | 53.8 | 1121 | 2083 |
| TF'd 85 C.-Ambient 48 hr | 0.69 | 26 | 28.2 | 385* | 1365 |
| TF'd 85 C.-ISO 48 hr-37 C./H2O | 0.68 | 62 | 46.9 | 899 | 1915 |
| TF'd 85 C.-ULS60 C. 2 hr | 0.69 | 61 | 51.0 | 1083 | 2122 |
| | | | | *20 hrs | |

a. The annealing effect of drying was seen comparing the 60° C. post package drying process to the 85° C. desiccant drying (higher drying temperature results in higher recovery, lower relaxation).
b. The thermoformed samples showed significantly reduced recovery and higher stress relaxation indicating most of the annealing effect is removed during this process.
c. Significant re-gain of performance was seen for samples wet annealed at 37° C. and wet annealed at 60° C. with sonic energy applied.
d. The correlation with stress relaxation and elastic recovery was good with some small differences possibly attributable to thickness.
e. The effect of improvement after 48 hr soak at 37° C. was surprising.

Zendura A samples were treated with three different conditions: 1) ULS treatment before tube wrapping (TW) at 60° C. for 2 hours; 2) ULS treatment after TW at 60° C. for 1 hour; 3) ULS treatment before TW at 60° C. for 2 hours and after TW at 60° C. for 1 hour. The experimental results are summarized in Table 2. Compared with control (no ULS treatment), Experiment #2 shows enhanced shape retention on Zendura A with ULS treatment before TW (61% vs 29% @ E 0 hr) while Experiment #3 exhibits enhanced shape recovery on Zendura A with ULS treatment after TW (84% vs 29% @ E 0 hr). A combination of ULS treatment before and after TW provide enhancement in both shape retention and shape recovery (97% vs 29% @ E 0 hr). Less recovery is observed on samples with post-TW ULS treatment (Exp #3 and #4 @E 0 hr vs @ E 24 h). There is no change in craze for ULS treated samples compared to untreated samples, while the Tg of treated samples are slightly higher (~1° C.) than untreated samples, indicating possibly more ordered polymer chain packing after ULS treatment.

TABLE 2

| | | Recovery | Recovery | | Tg |
|---|---|---|---|---|---|
| # | Treatment Conditin | 0 hr, % | 24 hr, % | Craze | (C.) |
| 1 | ZA Control, no treatment | 28.60 | 34.09 | 5/5 | 91.1 |
| 2 | ZA, ULS 60 C.-2 hr before tw | 60.90 | 68.62 | 5/5 | 92.1 |
| 3 | ZA, ULS 60 C.-1 hr at 24 hr recovery | 84.15 | 84.75 | 5/5 | 92.2 |
| 4 | ZA, ULS 60 C.-2 hr before tw + ULS | 96.78 | 97.23 | 5/5 | 92.3 |
| | 60 C.-1 hr at 24 hr recovery | | | | |

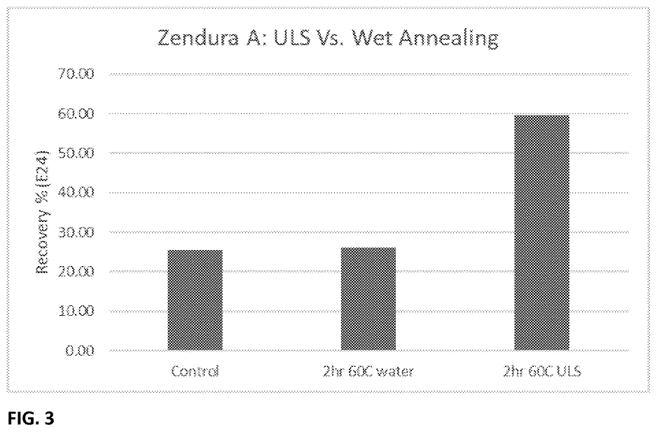

TW was performed on Zendura A samples with the following conditions: 1) No treatment as control; 2) Soaked in water at 60° C. for 2 hours; 3) ULS treated using Elma P70H at 60° C. for 2 hours. As shown in FIG. 3, there is no change in elastic recovery on wet annealing compared to the control, while significant enhancement is observed on ULS treated samples over the control for both materials. This is a strong indication that performance improvement is mainly from “ultrasonic energy”, not from “hot water” or wet annealing.

### Example 2: Synthetic Mono- and Triple-Layer TPU Materials

TPU materials BM143-195-2 (single layer), BM143-201-2 (single layer) and BM143-198 (triple layer) were prepared. Stress relaxation (SR) was performed on the samples of these materials with and without ULS treatment. The treatment conditions are 65° C. for 3 hours for the former two materials and 70° C. for 3 hour for the latter. The SR results are shown in Table 3. The force values shown in the table are normalized by sample thickness. Significant improvement in force retention is observed for all three in-house materials with ULS treatment.

TABLE 3

| | BM143-195-2 | | BM143-201-2 | | BM143-198 | |
|---|---|---|---|---|---|---|
| | Control | ULS Treated | Control | ULS Treated | Control | ULS Treated |
| Normalized Force, g @ 1 h | 1824 | 2631 | 2174 | 2694 | 1721 | 2048 |
| Normalized Force, g @ 24 h | 858 | 1949 | 1256 | 2057 | 999 | 1541 |
| Normalized Force, g @ 48 h | 724 | 1774 | 1049 | 1882 | 863 | 1411 |
| Retained Force % (24 hr/1 hr) | 47% | 74% | 58% | 76% | 58% | 75% |
| Retained Force % (48 hr/1 hr) | 40% | 67% | 48% | 70% | 50% | 69% |

### Example 3—Various Rigid Amorphous Polymer Materials

Materials: A list of the rigid amorphous or substantially amorphous polymers used for ultrasonic treatment, and evaluation is summarized in Table 4. The polymers list includes Thermoplastic Polyurethanes, Cyclic Olefin Compounds, Amorphous Polyamides, Tritan MP100, and PETG, PCTG and PCTA Copolyesters. Coextruded 3-layer sheet (BM141-37-3) using Isoplast 2531 outer layers and RxT50D inner layer (11-8-11 construction) substituted for the monolayer of 2531. Grilamid L25 PA12, a crystalline Polyamide is included for comparison.

TABLE 4
List of Amorphous Polymers by Trade name, Polymer Type, Density (g/cc),
Glass Transition Temperature Tg ° C., and Hot-Pressing Temperature(° C.).

| BM144-10- | Trade Name | Polymer Type | d, g/cc | Tg C. | Pressing, C. |
|---|---|---|---|---|---|
| 1 | Isoplast 2530 | TPU | 1.20 | 95 | 220 |
| 2 | Isoplast 2531 | TPU | 1.20 | 110 | 230 |
| 3 | BM141-37-3 | COEX: 2(2531)-RxT50D 11-8-11 | 1.2, 1.15 | 105 | 240 |
| 4 | PKFE | Phenoxy | 1.20 | 90 | 230 |
| 5 | Topas 8007F | COC | 1.01 | 80 | 230 |
| 6 | Topas 5013 | COC | 1.02 | 135 | 230 |
| 7 | Plexiglass V825 | PMMA | 1.19 | 105 | 230 |
| 8 | Kumho 335T | SAN | 1.20 | 95 | 230 |
| 9 | Grilamid TR55LX | Rigid Amorphous Polyamide | 1.04 | 95 | 260 |
| 10 | Grilamid TR90 | Rigid Amorphous Polyamide | 1.00 | 150 | 260 |
| 11 | Tritan MP100 | TMCBD | 1.20 | 110 | 260 |
| 12 | Eastar 6763 | PETG | 1.27 | 80 | 260 |
| 13 | Durastar MN621 | PCTA | 1.20 | 85 | 260 |
| 14 | Durastar MN611 | PCTG | 1.20 | 82 | 260 |
| 15 | Eastar 6763 | PETG | 1.27 | 80 | 260 |
| BM144-16-2 | Grilamid L25 | PA12: Crystalline Polyamide | 1.01 | 50 | 240 |

Samples Preparation: Amorphous Polymers were dried in a vacuum oven, and hot-pressed into 6×6×0.030 in. sheets in a Carver Press, at the process temperatures shown in Table 4. A two minute pre-heat was followed by pressing for two minutes, under 8-10 tons pressure, and cold clamping in a second Carver Press at about 60° C.

Samples Conditioning: Three different Conditioning processes were applied to the pressed sheets:
i. Heating in a hot air oven, to remove thermal history. Pressed sheets thermal history was removed by heating the different polymers for 20 minutes in an oven, at temperatures at least 20° C. above Tg, then taking out to room temperature, as shown in Table 5. This heating process is basically designed to bring all different polymers to a normalized starting point.
ii. Heating Immersed in 60° C. de-ionized water. Polymer Sheets with normalized thermal history, were punched into six strips (1×4 in). Three strips (plus a tiny strip for DSC), were immersed in de-ionized water in a glass container, and heated in an oven at 60° C. for two hours.
iii. Ultrasonic treatment immersed in 60° C. de-ionized water. An ultrasonic bath, Branson 2510, was set to 60° C. water temperature. Three 1×4″ strips (plus a tiny strip for DSC), immersed in 300 ml de-ionized water in a glass container, were placed in the bath, and allowed to equilibrate to set temperature. Sonication was turned on for two hours. Sonicated sample strips were then removed to room temperature. Eastar 6763 was also conditioned at a lower temperature of 50° C. Grilamid L25 was conditioned at a lower temperature of 37° C.

TABLE 5
Three different Conditioning Processes(A, B, C) applied to polymer sheets:

| | | A | B | C |
|---|---|---|---|---|
| | | Air OVEN | OVEN | Branson 2510 |
| BM144-10- | Trade Name | 20° C. > Tg 20′ | in DI-H2O | in DI-H2O |
| 1 | Isoplast 2530 | 115 | 60 C./H2O2 hr | ULS 60 C. 2 hr |
| 3 | BM141-37-3 COEX | 120 | 60 C./H2O2 hr | ULS 60 C. 2 hr |
| 5 | Topas 8007F | 105 | 60 C./H2O2 hr | ULS 60 C. 2 hr |
| 9 | Grilamid TR55LX | 115 | 60 C./H2O2 hr | ULS 60 C. 2 hr |
| 10 | Grilamid TR90 | 165 | 60 C./H2O2 hr | ULS 60 C. 2 hr |
| 11 | Tritan MP100 | 130 | 60 C./H2O2 hr | ULS 60 C. 2 hr |
| 12 | Eastar 6763 | 105 | 60 C./H2O2 hr | ULS 60 C. 2 hr |
| 15 | Eastar 6763 | 105 | 50 C./H2O2 hr | ULS 50 C. 2 hr |
| 16-2 | Grilamid L25 | | 37 C./H2O2 hr | ULS 37 C. 2 hr |

### Testing:

1. Tube Wrap Test. Tube wrap tests were run on 60° C./H2O/2 hr-heated strips and 60° C./H2O/2 hr-sonicated strips, three each.

2. DSC scans. All Polymer samples, with different conditionings, i) heat-normalized, ii) Immersed in 60° C. water, in an oven for two hours, and iii) sonicated in water at 60° C. or 50° C. for two hours, were scanned for DSC first heat or first and second heat, at 10° C./minute. Tg (° C.) values were obtained for comparison.

Results: Table 6 shows initial and 24 hour elastic recovery % for the different polymers, tested after three Conditioning Treatments, a) 48 hour at Ambient temperature, b) 2 hours immersion in 60° C. water, and c) 2 hours Sonication immersed in 60° C. water; Eastar 6763 Recovery %, after 50° C. Treatments; Grilamid L25 recovery % after four Conditioning Treatments as described.

TABLE 6
Initial and 24 hour Elastic Recovery % for Different Polymers

| | Description | Treatment | thickness (mm) | 0 hr Recovery % | 24 hr Recovery % |
|---|---|---|---|---|---|
| BM144-10-9B | Grilamid TR55LX | 60 C. H2O 2 hr | 0.83 | 36.3 | 47.8 |
| BM144-10-11B | Tritan MP100 | 60 C. H2O 2 hr | 0.82 | 77.8 | 84.7 |
| BM144-10-5B | Topas 8007F | 60 C. H2O 2 hr | 0.83 | 59.7 | 64.3 |
| BM144-10-12B | Eastar 6763 | 60 C. H2O 2 hr | 0.75 | 31.9 | 30.7 |
| BM144-10-9C | Grilamid TR55LX | ULS 60 C. 2 hr | 0.8 | 41.5 | 53.2 |
| BM144-10-11C | Tritan MP100 | ULS 60 C. 2 hr | 0.82 | 91.7 | 96.7 |
| BM144-10-5C | Topas 8007F | ULS 60 C. 2 hr | 0.83 | 70.7 | 75.9 |
| BM144-10-12 | Eastar 6763 | ULS 60 C. 2 hr | 0.75 | 28.4 | 25.6 |
| BM144-10-12A | Eastar 6763 | Ambient 48 hr | 0.73 | 28.9 | 25.0 |
| BM144-10-15Bii | Eastar 6763 | 50 C. H2O 2 hr | 0.73 | 25.6 | 28.0 |
| BM144-10-15Cii | Eastar 6763 | ULS 50 C. 2 hr | 0.74 | 49.1 | 52.4 |
| BM144-10-10Aii | Grilamid TR90 | Ambient 48 hr | 0.82 | 39.5 | 49.2 |
| BM144-10-10Bii | Grilamid TR90 | 60 C. H2O 2 hr | 0.78 | 51.9 | 66.6 |
| BM144-10-10Cii | Grilamid TR90 | ULS 60 C. 2 hr | 0.79 | 66.9 | 79.7 |
| BM144-10-1A | ZenduraA-TX-Rotary 60 C. 24 hr | Ambient 48 hr | 0.76 | 26.9 | 32.5 |
| BM144-10-1B | ZenduraA-Rotary: BM138-167-1 | 60 C. H2O 2 hr | 0.77 | 42.9 | 52.7 |
| BM144-10-1C | ZenduraA-Rotary: BM138-167-1 | ULS 60 C. 2 hr | 0.76 | 56.0 | 66.4 |
| BM141-37-3A | COEX 2(2531)-RxT50D | Ambient 48 hr | 0.73 | 23.1 | 27.8 |
| BM144-10-3B | COEX 2(2531)-RxT50D: BM141-37-3 | 60 C. H2O 2 hr | 0.71 | 53.6 | 63.9 |
| BM144-10-3C | COEX 2(2531)-RxT50D: BM141-37-3 | ULS 60 C. 2 hr | 0.69 | 78.3 | 86.7 |
| BM144-16-2Ai | Grilamid L25 (PA12) | Ambient 48 hr | 0.8 | 49.5 | 64.4 |
| BM144-16-2Aii | Grilamid L25 (PA12) | 100 C. 10 min | 0.8 | 55.2 | 75.0 |
| BM144-16-2Bii | Grilamid L25 (PA12) | 37 C. H2O 2 hr | 0.79 | 46.2 | 64.4 |
| BM144-16-2Cii | Grilamid L25 (PA12) | ULS 30 C. 2 hr | 0.8 | 52.5 | 68.5 |

DSC Results: Table 7 shows DSC glass transition temperature Tg° C., for different polymer systems after three treatments:

TABLE 7
DSC Glass Transition Temperature Tg ° C., for Different Polymer Systems after three Treatments: a) Normalized
by Heating 20° C. above Tg, b) 2 hours immersion in 60° C. water, c) 2 hours Sonication immersed in 60° C. water.

| | | A | | | DSC | DSC | DSC |
|---|---|---|---|---|---|---|---|
| | | Air OVEN | B | C | A | B | C |
| BM144- | | (20° C. > Tg) | OVEN | Branson 2510 | p-20° C. > Tg 20′ | p-60 C./H2O/2 hr | p-ULS 60 C./H2O/2 hr |
| 10- | Trade Name | 20 min. | in DI-H2O | in DI-H2O | 1st & 2nd Ht Tg° C. | 1st Ht Tg° C. | 1st Ht Tg° C. |
| 1 | Isoplast 2530 | 115 | 60 C./H2O2 hr | ULS 60 C. 2 hr | 90.1 93.6 | 84.9 | 83.4 |
| 3 | BM141-37-3 COEX | 120 | 60 C./H2O2 hr | ULS 60 C. 2 hr | 104.1, 106.1 | 101.6 | 100.9 |
| 5 | Topas 8007F | 105 | 60 C./H2O2 hr | ULS 60 C. 2 hr | 79.3, 76.3 | 79.7 | 79.6 |
| 10 | Grilamid TR90 | 165 | 60 C./H2O2 hr | ULS 60 C. 2 hr | 136.8, 152.3 | 135.7 | 133.2 |
| 11 | Tritan MP100 | 130 | 60 C./H2O2 hr | ULS 60 C. 2 hr | 107.8 108.4 | 104.3 | 105.1 |
| 12 | Eastar 6763 | 105 | 60 C./H2O2 hr | ULS 60 C. 2 hr | 78.0, 79.1 | 77.5 | 76.4 |
| 15 | Eastar 6763 | 105 | 50 C./H2O2 hr | ULS 50 C. 2 hr | 78.0, 79.1 | 77.9 | 76.0 |
| 16-2 | Grilamid L25 | | 37 C./H2O2 hr | ULS 37 C. 2 hr | 50.0 | | |

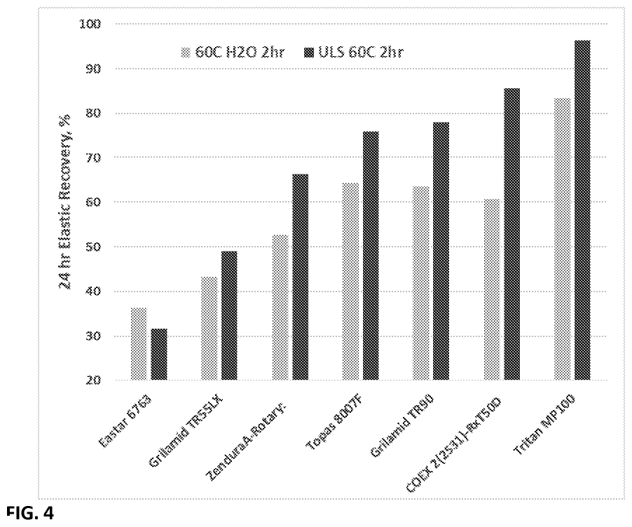

Analysis: With the exception of Eastar 6763, the different polymers exhibited between 13% and 41% higher % recovery after Ultrasonic Annealing in 60° C. water, compared to simply heating in 60° C. water (wet-annealing), for two hours, as shown in Table 8 and Graph 1 (FIG. 4). ZenduraA Ultrasonic annealing resulted in 26% higher recovery over wet-annealing. Ultrasonically-annealed COEX #BM141-37-3 2 (2531)-RxT50D showed the greatest improvement in recovery, 41% higher than wet-annealed counter parts.

TABLE 8
24 hour Recovery %, in various Rigid Amorphous Polymers
After Conditioning for two hours in 60° C. de-ionized
water with or without application of Ultrasonic Power.

| | Recovery % | Recovery % |
|---|---|---|
| Amorphous Polymer | 60 C. H2O 2 hr | ULS 60 C. 2 hr |
| Eastar 6763 | 36.3 | 31.7 |
| Grilamid TR55LX | 43.2 | 49.0 |
| ZenduraA-Rotary: | 52.7 | 66.4 |
| Topas 8007F | 64.3 | 75.9 |
| Grilamid TR90 | 63.6 | 77.9 |
| COEX 2(2531)-RxT50D | 60.7 | 85.5 |
| Tritan MP100 | 83.4 | 96.4 |

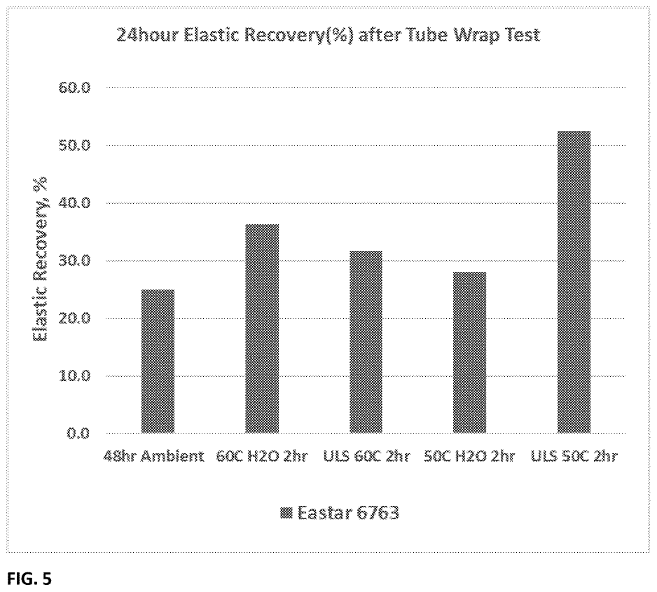

Ultrasonic annealing of Eastar 6763 is more favorable at a lower temperature of 50° C., compared to 60° C., yielding 52.4% recovery versus 31.7%. This is an example of a polymer (PETG), where Ultrasonic annealing is preferably performed at a temperature 29° C. below Tg (79° C.) compared to 19° C., as shown in Table 9 and Graph 2 (FIG. 5).

TABLE 9
24 hour Recovery %, in Eastar 6763 PETG
Conditioned in five different manners.

| Condition | Eastar6763 |
|---|---|
| 48 hr Ambient | 25.0 |
| 60 C. H2O2 hr | 36.3 |
| ULS60 C. 2 hr | 31.7 |
| SOC H2O2 hr | 28.0 |
| ULSSOC 2 hr | 52.4 |

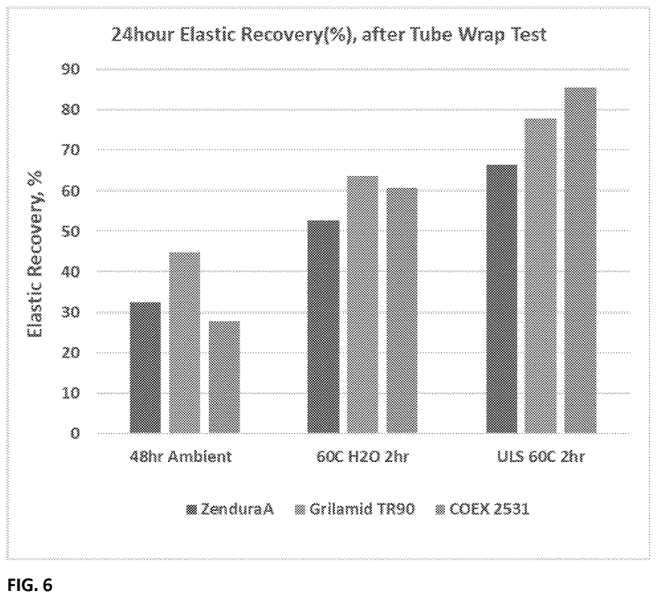

Table 10 and Graph 3 (FIG. 6), show examples of a rigid amorphous Polyurethane (ZenduraA), Polyamide (TR90) and a coextruded 3-layer product with rigid outer layers surrounding a softer elastomeric urethane, all exhibiting substantially enhanced recovery properties after ultrasonic annealing compared to unmodified or wet-annealing.

TABLE 10
24 hour Recovery %, in ZenduraA, Grilamid TR90 and COEX 2531,
tested after three different Conditions: 48 hours at Ambient
Temperature; two hours in 60° C. de-ionized water; two
hours in 60° C. de-ionized water with Ultrasonic Power on.

| | BM144-10-1 | BM144-10-10 | BM141-37-3 |
|---|---|---|---|
| Condition | ZenduraA | Grilamid TR90 | COEX 2531 |
| 48 hr Ambient | 32.5 | 44.7 | 27.83 |
| 60 C. H2O 2 hr | 52.7 | 63.6 | 60.7 |
| ULS 60 C. 2 hr | 66.4 | 77.9 | 85.5 |

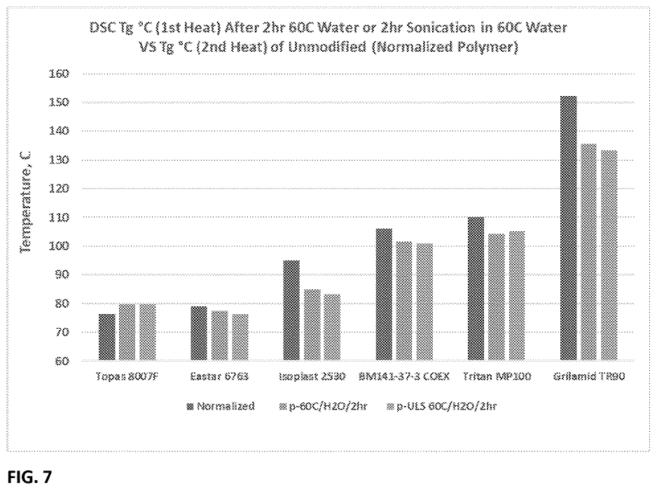

Glass Transition Temperature (Tg° C.) values taken from DSC 2nd Heat scans served as the Normalized Tg values (or starting point), for all polymers tested. After different treatments (60° C. water or Sonicated in 60° C. water, for two hours), Tg values were taken from DSC first Heats. The difference in Tg values between normalized numbers and post conditioning is evaluated, as a measure of the treatment-induced change. Generally, all polymers tested (with the exception of Topas 8007F) showed a decrease of a few degrees in Tg° C. after immersion in 60° C. water or sonication in 60° C. water, for two hours, as shown in Table 11 and Graph 4 (FIG. 7). Sonicated samples show a slightly lower Tg compared to non-sonicated counterparts.

TABLE 11
DSC Heat1 or Heat2 Tg ° C. values, for various Rigid
Amorphous Polymers, after different Conditioning: Normalized;
60° C./H2O/2 hr; Sonicated in 60° C./H2O/2 hrs.

| | | | Heat 1 | Heat 1 |
|---|---|---|---|---|
| | | Heat 2 | p-60 C./ | p-ULS 60 C./ |
| | ID | Normalized | H2O/2 hr | H2O/2 hr |
| 5 | Topas 8007F | 76.3 | 79.7 | 79.6 |
| 12 | Eastar 6763 | 79.1 | 77.5 | 76.4 |
| 1 | Isoplast 2530 | 95 | 84.9 | 83.4 |
| 3 | BM141-37-3 COEX | 106.1 | 101.6 | 100.9 |
| 11 | Tritan MP100 | 110 | 104.3 | 105.1 |
| 10 | Grilamid TR90 | 152.3 | 135.7 | 133.2 |

### Summary of Certain Findings:

a. Ultrasonic Low Temperature Annealing of ZenduraA has been validated. ZenduraA (Rotary 60° C. 24 hours) Ultrasonically-annealed two hours in 60° C. water results in 66% Elastic Recovery (tube wrap test) compared to 33% and 53% in unmodified and wet-annealed counter parts.
b. Enhanced Elastic Recovery (%) after Ultrasonic Low Temperature annealing, has also been verified in other rigid amorphous Polymers including Copolyesters (Tritan MP100, and Eastar 6763), Polyamides (Grilamid TR90 and TR55LX), Cyclic Olefin Compounds (Topas 8007F) and Coextruded three-layer Polyurethanes (Isoplast 2531-RxT50D-Isoplast 2531).
c. Substantially enhanced Force retention (Stress Relaxation tests) has been verified in thermoformed flat parts after Ultrasonic Low Temperature Annealing.
d. Generally, all elastic recovery results in 60° C.-2 hour Ultrasonically-treated Polymers and COEX 3-layer sample were favorable and greater than non-sonicated parts. Ultrasonically-treated ZenduraA showed 66% Recovery compared to 33% in unmodified parts. However, counterparts (immersed in 60° C. water for two hours) exhibited 53% recovery, i.e. not far behind the sonicated. This result is actually not totally surprising; known as wet annealing, and has been covered in Bay Materials U.S. Pat. No. 8,716,425, which is incorporated herein by reference. What is surprising is wet-annealing effectiveness in two hours, compared to longer hours (e.g. 24 hours) reported earlier. DSC scans were used to measure any changes in Tg values after different treatments; typically a small decrease (few degrees) in Tg temperature is observed after wet-annealing, or ultrasonic annealing.

### Example 4

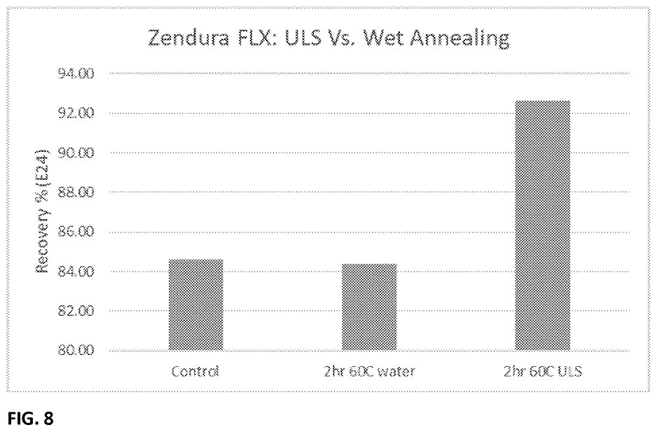

TW was performed on Zendura FLX samples with the following conditions: 1) No treatment as control; 2) Soaked in water at 60° C. for 2 hours; 3) ULS treated using Elma P70H at 60° C. for 2 hours. As shown in FIG. 8, there is no change in elastic recovery on wet annealing compared to control, while significant enhancement is observed on ULS treated samples over control for both materials. This is a good indication that performance improvement is mainly from “ultrasonic energy”, not from “hot water” or wet annealing.

### Example 5: ULS Time Effect Study on ZenduraA and FLX

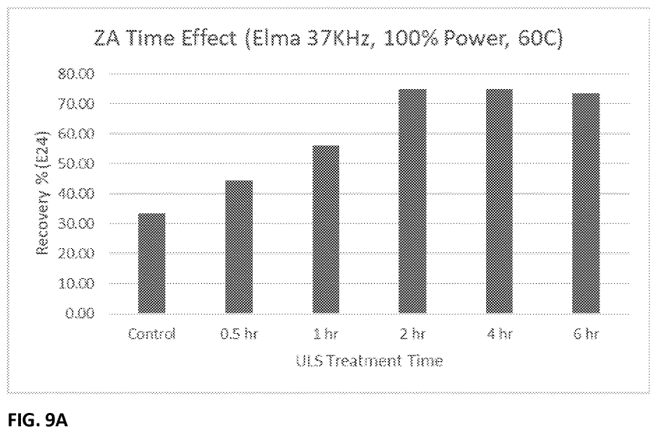

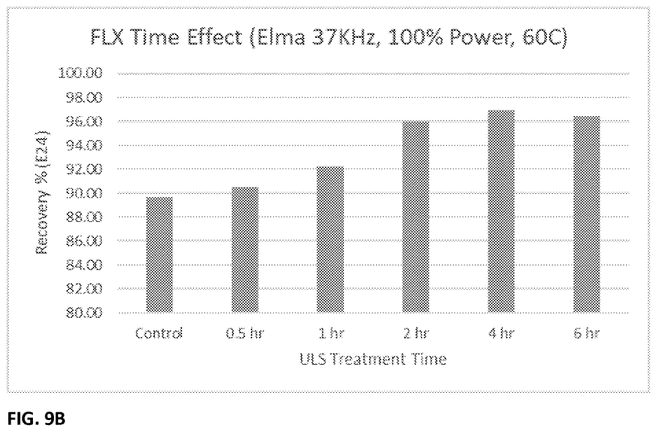

ULS treatments of various time periods at 0.5, 1, 2, 4 and 6 hours were carried out using Elma model at 60° C. with 37 KHz and full power on both Zendura A and Zendura FLX followed via TW evaluation. Compared with untreated samples, the improved elastic recovery % increases from 0.5 to 2 hours while levels from 2 to 6 hours as shown in FIG. 9A and FIG. 9B. The improvement and increase are more obviously observed in Zendura A than in Zendura FLX.

SR is also used for the evaluation of unthermoformed and thermoformed Zendura FLX samples with different ULS treatment time periods. As summarized and compared in Table 12 and Table 13, with increased ULS treatment time, the force retention property of the material is gradually improved for both unformed and formed cases.

TABLE 12

| | OOBB- | Zendura FLX, ULS-Treated, 37 KHz 60 C. Full Power | | | | |
|---|---|---|---|---|---|---|
| | Ambient | 0.5 Hr | 1 Hr | 2 Hrs | 4 Hr | 6 Hr |
| Force, g @ 1 h | 1709 | 1613 | 1586 | 1710 | 1830 | 1736 |
| Force, g @ 24 h | 1245 | 1218 | 1260 | 1337 | 1458 | 1389 |
| Force, g @ 48 h | 1197 | 1207 | 1180 | 1251 | 1395 | 1356 |
| Retained Force % (24 hr/1 hr) | 73% | 75% | 79% | 78% | 80% | 80% |
| Retained Force % (48 hr/1 hr) | 70% | 75% | 74% | 73% | 76% | 78% |

TABLE 13

| | H2O-Soaked | Zendura FLX TF'd, ULS | | |
|---|---|---|---|---|
| | 60 C. 1 Hr | 0.5 Hr | 1 Hr | 2 Hr |
| Force, g @ 1 h | 1433 | 1407 | 1503 | 1553 |
| Force, g @ 24 h | 1077 | 1078 | 1170 | 1246 |
| Force, g @ 48 h | 1036 | 1004 | 1074 | 1175 |
| Retained Force % (24 hr/1 hr) | 75% | 77% | 78% | 80% |
| Retained Force % (48 hr/1 hr) | 72% | 71% | 72% | 76% |

### Example 6: ULS Temperature Effect Study on Zendura A and FLX

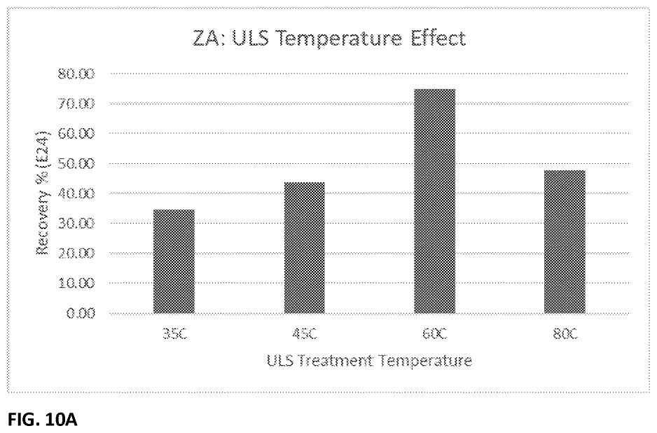

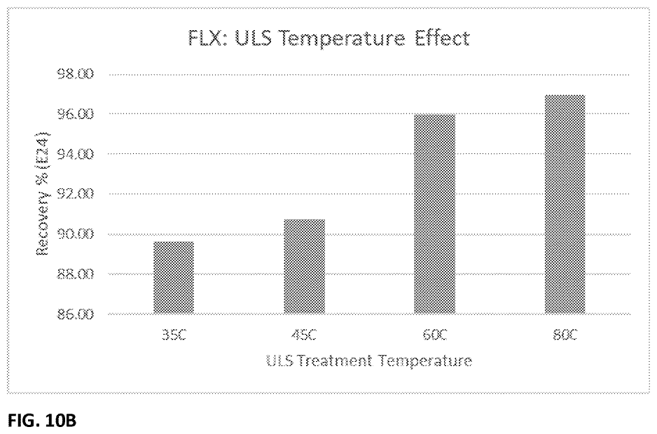

ULS treatment of different temperatures at 35, 45, 60 and 80° C. was carried out using Elma model for 2 hours with 37 KHz and full power on both Zendura A and Zendura FLX followed via TW evaluation (FIG. 10A and FIG. 10B). For Zendura A, elastic recovery % increases with the increase of temperature from 35° C. to 60° C., then drops at 80° C. For Zendura FLX, gradual increase in elastic recovery % is observed from 35° C. to 80° C. This is due to the fact that Zendura A possesses a Tg of 90° C. while the outer shell of Zendura FLX has a Tg around 110 C. At 80° C., Zendura A samples will warp while Zendura FLX samples are intact. A reasonable temperature limit for ULS treatment should be about 30° C. below material Tg.

### Example 7: ULS Power Effect Study on Zendura A and FLX

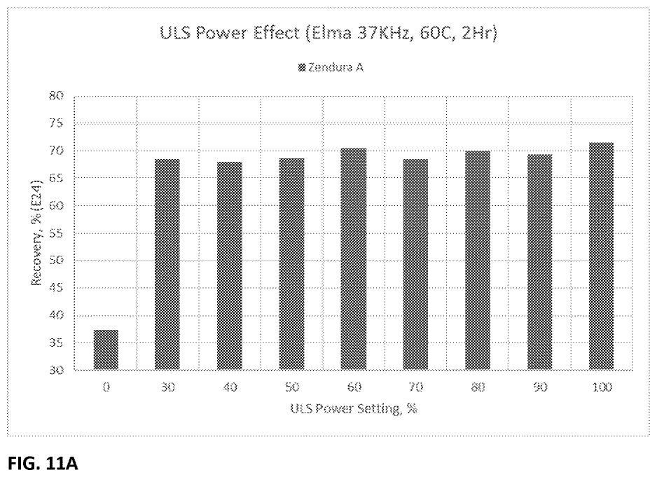

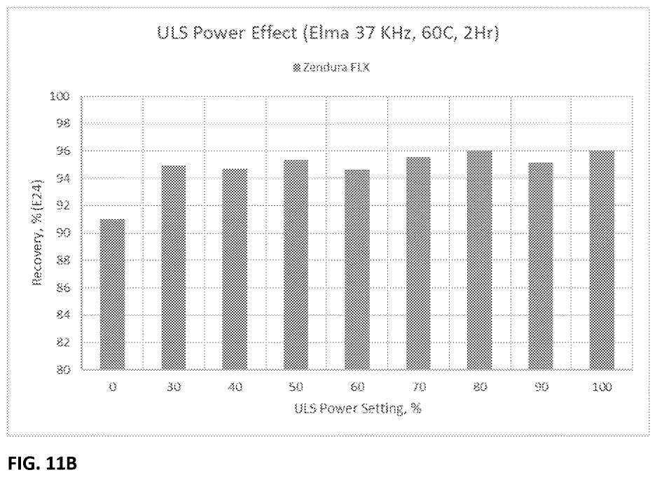

ULS treatments at various power setting levels of 30, 40, 50, 60, 70, 80, 90 and 100% were applied on both Zendura A and Zendura FLX samples using Elma model at 37 KHz and 60° C. for 2 hours followed by TW evaluation. As shown in FIG. 11A and FIG. 11B, although Zendura A shows larger improvement in elastic recovery % with ULS treatment over control than Zendura FLX, there is no clear trend in such improvement with the increase of power level for both materials.

### Example 8: ULS Frequency Effect Study on Zendura A and FLX

ULS treatments at different frequency were carried out on two different ultrasonic devices, with Elma model at 37 and 80 KHz and Langee model at 40, 80 and 120 KHz, and evaluated with untreated samples through TW experiment. For both, the samples are treated at 60° C. for 2 hours with full ULS power. As shown in FIG. 12, improvement in elastic recovery is found for both Zendura A and Zendura FLX samples with ULS treatment, while the effect on Zendura A is significantly larger than on Zendura FLX. Compare the performance at different frequencies, no significant difference is found for treated Zendura A or Zendura FLX samples with both Elma and Langee models.

### Example 9: ULS Mode Effect Study on Zendura A and FLX

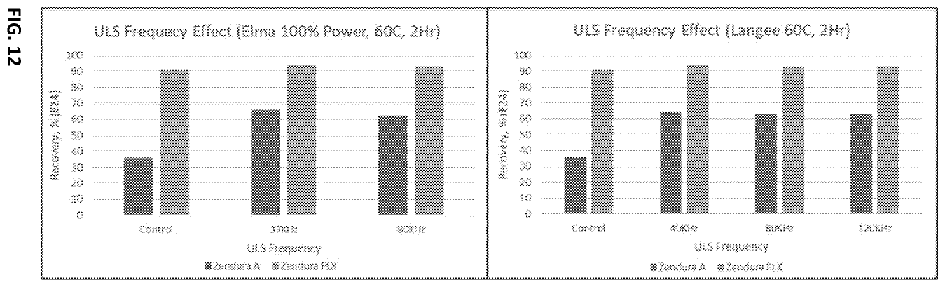

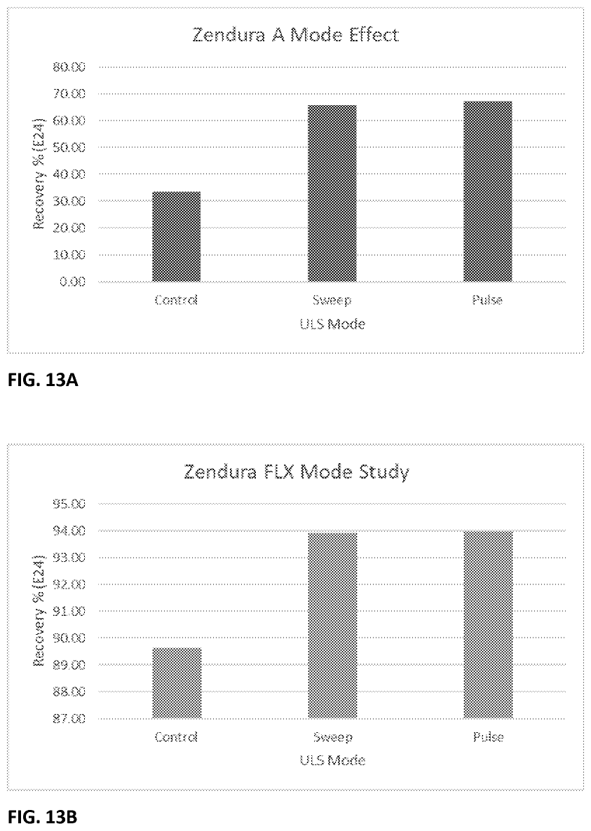

ULS treatment under different modes (Sweep and Pulse) were carried out using Elma model at 37 KHz and 60° C. for 2 hours with full power on both Zendura A and Zendura FLX followed by TW evaluation. As shown in FIG. 13A and FIG. 13B, although there is enhancement in elastic recovery % over control with Zenduar A showing larger effect than Zendura FLX, there is no clear difference in the enhancement effect between the two treatment modes for both materials.

### Example 10: Zendura FLX Mimic Patient Different Wearing Time, Formed vs Unformed

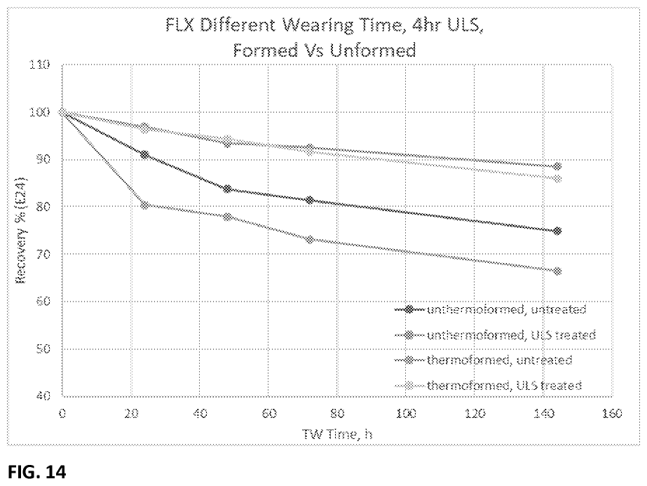

To mimic different patient wearing times, TW of unthermoformed and thermoformed Zendura FLX samples at various length of 24, 48, 72 and 144 hours was carried out and elastic recovery % at t=24 h was used for analysis. For each wrapping time, untreated samples and samples with ULS treatment using Elma at 37 KHz at 60° C. for 4 hours full power were prepared and run side by side. As shown in FIG. 14, longer wrapping time leads to lower 24 hours elastic recovery %. Samples with ULS pre-treatment are observed to possess better recovery property than those untreated. Such improvement is getting larger with TW time increase. The formed sample, with its thermal history removed after heating above material Tg, shows lower recovery % than unformed sample. However, after ULS treatment, the recovery % for formed and unformed samples are about the same at different TW time.

### Example 11: Formed Zendura FLX Mimicking Different Patient Wearing Times, Wet Annealing Vs ULS Treatment

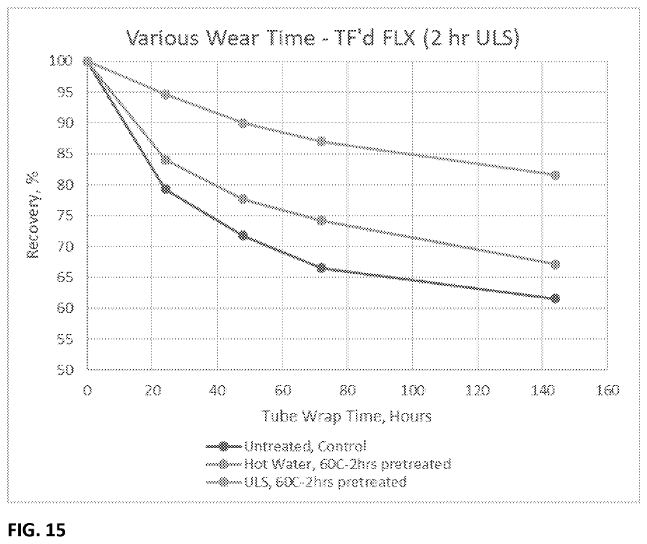

To study the enhancement effect of wet annealing vs. ULS annealing, similar TW experiments of thermoformed Zendura FLX samples is performed with the pre-treatment of 60° C. in water for 2 h or ULS at 60° C. for 2 h. Compared with control, improvement in recovery % are observed for both wet annealing and ULS treatment as shown in FIG. 15. The improvement with ULS treatment is greatly larger than that of wet annealing, especially in longer wearing time from 72 to 144 h. This indicates that the improvement via ULS treatment is mainly contributed from “ultrasonic energy”, not “hot water”.

### Example 12: Zendura FLX Mimicking Patient On-and-Off Behavior

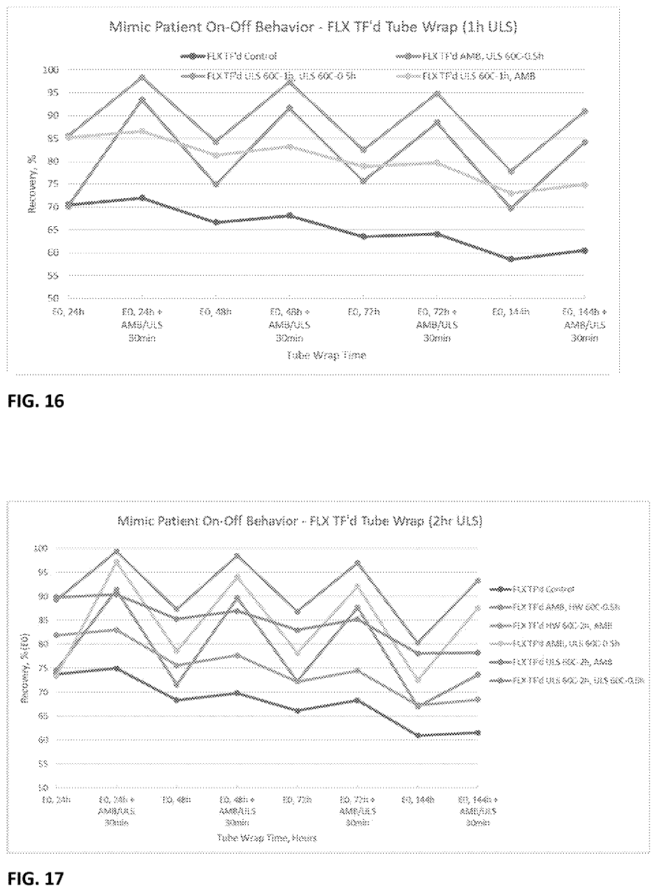

To mimic patient on-and-off behavior, TW evaluation of formed Zendura FLX samples was performed and elastic recovery % at t=0 is used for analysis: i) No pre- and post-treatment as control; ii) NO pre-treatment, 30 min ULS treatment after each TW; iii) ULS pre-treatment at 60° C. for 1 h, 30 min post-treatment after each TW; iv) ULS pre-treatment at 60° C. for 1 h, no post-treatment. As summarized in FIG. 16, a total of four low-high cycles are shown in each of the curves representing different sample and treatment conditioning. The samples without pre-treatment have the lower elastic recovery % than sample with ULS treatment. Samples with post-treatment will have significant increase in recovery % (high's) from TW low's. The samples with both pre- and post-treatment, possess higher recovery % at both low's and high's. In particular, the recovery of the two samples with both pre- and post-treatment after four full on-and-off cycles are still over 90%, compared with samples with post-treatment only of ~85% and untreated samples of 60%. This is a good indication that ULS treatment can significantly enhance shape retention and shape recovery properties of the material.

### Example 13: Zendura FLX Mimicking Patient On-and-Off Behavior, Wet Annealing Vs. ULS Treatment

As ULS treatment can improve shape retention and shape recovery from previous experiment, it is meaningful to identify how much such improvement is from wet annealing and how much from “pure” ULS energy. Similar TW experiments on thermoformed Zendura FLX samples were further carried out with the following conditions: i) No treatment as control; ii) No pre-treatment, wet annealing at 60° C. for 30 min after each TW; iii) Pre-treatment of wet annealing at 60° C. for 2 h, no post treatment; iv) No pre-treatment, ULS post-treatment at 60° C. for 30 min after each TW; v) ULS pre-treatment at 60° C. for 2 h, no post-treatment; vi) With both ULS pre-treatment at 60° C. for 2 h and post-treatment at 60° C. for 30 min. As shown in FIG. 17, in addition to the trends being described above, the following is observed: 1) Comparing ii) with iv), although both have boosting effect on shape recovery, ULS will improve the property more than wet annealing under the same treatment time, especially after the full four TW on-and-off cycles (88% vs. 74%). 2) Comparing iii) and v), ULS will improve recovery % more than wet annealing with the same amount of treatment time at the same temperature with the difference gradually getting larger along TW cycles (difference from 7% to 10%). 3) The sample with no treatment possesses the lowest recovery while the sample with both ULS pre- and post-treatment provides the highest recovery.

The present embodiments advantageously provide improved force retention and shape recover properties in polymeric materials. For dental appliances, such as dental aligners, made of polymeric materials, present embodiments advantageously provide improved force retention and shape recover properties in the dental appliances, which leads to optimized tooth movement and more predictable outcomes, allowing improved treatment and user experience for customers. Additionally, embodiments herein offer a rapid and cost-effective way to produce orthodontic appliances with better shape fixity, elasticity and improved tooth moving force. Moreover, a customer is able to easily activate the appliance (e.g., aligner) while cleaning the appliance in a bath with simultaneous sonication.

Appendix A, of U.S. Provisional Patent Application No. 63/597,791, which is incorporated by reference, discloses additional data and examples. Additional embodiments, materials, material parameters and properties, constructions methods, definitions, etc., useful for embodiments herein can be found in U.S. Pat. Nos. 10,549,511, 10,946,630, 10,870,263, 10,987,907, and 8,716,425, which are each incorporated by reference for all purposes.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of treating a polymeric material comprising:
exposing the polymeric material to ultrasonic energy in a liquid medium at a temperature below a glass transition temperature of the polymeric material for a time sufficient to modify one or more properties, or to reduce surface or internal stress, of the polymeric material, the one or more properties including stress relaxation, shape recovery, glass transition temperature, and crystallinity.

2. The method according to claim 1, wherein the temperature is from about room temperature to about 5° C. below the glass transition temperature of the polymeric material.

3. The method according to claim 1, further including determining the glass transition temperature of the polymeric material.

4. The method according to claim 1, wherein the exposing includes, thermoforming the polymeric material into a thermoformed article having a geometry, and thereafter exposing the thermoformed article to the ultrasonic energy in the liquid medium.

5. The method according to claim 4, wherein the thermoformed article comprises a dental appliance.

6. The method according to claim 1, wherein the dental appliance is made via a 3D printing process or a molding process.

7. The method according to claim 1, wherein the polymeric material comprises two or more layers of different polymers.

8. The method according to claim 1, wherein the polymeric material comprises a single polymer.

9. The method according claim 1, wherein the polymeric material includes one or more polymers selected from the group consisting of polyamides, polyimides, polyurethanes, polyesters, polyureas, polycarbonates, polyether diols, polyolefins, polyacrylates, polymethacrylates, polystyrenes, polysulfones, polyaryl ethers, silicones, and cellulose.

10. The method according to claim 1, wherein the ultrasonic energy comprises one or more frequencies between about 5 KHz and 1000 KHz, 5 KHz and 500 KHz, 10 KHz and 200 KHz, 10 KHz and 150 KHz, or 10 KHz and 100 KHz.

11. The method according to claim 1, wherein the ultrasonic energy has an energy density of between about 0.005 W/ml to about 0.25 W/ml.

12. The method according to claim 1, wherein the polymeric material is substantially amorphous or semi-crystalline.

13. A dental appliance with improved properties comprising a polymeric material treated according to the method of claim 1.

14. A method of reducing stress relaxation and/or creep in a polymeric article, the method comprising:
adjusting a temperature of the polymeric article in a liquid medium to a temperature that is below a glass transition temperature of the polymeric material; and
exposing the polymeric article to ultrasonic energy in the liquid medium at the temperature for a time sufficient to reduce stress relaxation of the polymeric article,
wherein the exposing the polymeric article to ultrasonic energy reduces stress relaxation and/or creep resistance in the polymeric article by at least about 5% or 10% as compared to the stress relaxation and/or creep resistance of the polymeric article before the exposing.

15. The method according to claim 14, wherein the temperature is from about 50° C. to about 5° C. below the glass transition temperature of the polymeric article.

16. The method according to claim 14, wherein the polymeric article is a dental appliance.

17. The method according to claim 14, wherein the polymeric article is substantially amorphous or semi-crystalline.

18. A system for modifying the properties of a dental appliance, the system comprising:
the dental appliance, wherein the dental appliance comprises a polymeric material;
an ultrasonic treatment device comprising a fluid containing chamber, a heating (or cooling) element configured to heat the fluid containing chamber, and an ultrasonic transducer, wherein the treatment device is configured to adjust a temperature of the dental appliance in the fluid containing chamber to a temperature that is below a glass transition temperature of the polymeric material; and activate the ultrasonic transducer to subject the dental appliance to ultrasonic energy in the fluid containing chamber at the temperature for a time sufficient to reduce stress relaxation of the polymeric material.

19. The system of claim 18, wherein the dental appliance being subjected to ultrasonic energy reduces stress relaxation and/or creep resistance in the polymeric material by at least about 10% as compared to the stress relaxation and/or creep resistance of the polymeric material before being subjected to ultrasonic energy.

20. The system according claim 18, wherein the polymeric material includes one or more polymers selected from the group consisting of polyamides, polyimides, polyurethanes, polyesters, polyureas, polycarbonates, polyether diols, polyolefins, polyacrylates, polymethacrylates, polystyrenes, polysulfones, polyaryl ethers, silicones, and cellulose.
